(19) United States
(12) Patent Application Publication
(10) Pub. No.: US 2006/0039513 A1
(43) Pub. Date: Feb. 23, 2006

(54) Clock and data recovery systems and methods

(76) Inventors: Ruey-Bin Sheen, Taichung (TW); Chih-Hsien Chang, Taipei (TW)

Correspondence Address: BIRCH STEWART KOLASCH & BIRCH, PO BOX 747, FALLS CHURCH, VA, 22040-0747, US

(21) Appl. No.: 10/919,429

(22) Filed: Aug. 17, 2004

(51) Int. Cl. H04L 7/00

(52) U.S. Cl. 375/355

(57) ABSTRACT

Methods of clock and data recovery (CDR) are provided. An exemplary method comprises extending the eye of the data stream by examining transitions of adjacent samples, detecting whether an island sample exists in each symbol according to the separation of the transitions, and altering the value of the neighboring samples near the island sample to be equal to the island sample.

### BACKGROUND

The present invention relates to clock and data recovery (CDR) systems, and more specifically, to eye extension techniques for enhancing signal integrity in a receiver.

In a data link system, clock and data recovery (CDR) is one of the most important functional blocks in the receiving end. The efficiency and accuracy of the CDR affects the performance of the data transmission directly. The CDR extracts the clock and regenerates the data from the received data stream for a data link operation. In general, two techniques, phase-locked loop (PLL) and phase picker are commonly used for CDR implementation.

A PLL shown in FIG. 1 uses a feedback loop control to adjust the phase of the sampling clock for recovering the data in the received stream. As shown in FIG. 1, the PLL 1 includes three major components: a multiplier 12, a loop filter 14, and a voltage-controlled oscillator (VCO) 16 connected together in the form of a feedback system. The object of the PLL 1 is to generate a VCO output r(t) that has the same phase angle as the input signal s(t).

The phase picker scheme extracts the data by over sampling the received signals. The sampled data are used to detect the transition position, i.e., the position at which the data changes its state from high to low or low to high. The best sample is selected as the data value based on the transition position information.

The signal integrity of a signal in a data link system degrades as the signal passes through the channel, which introduces jitters into data transitions in the received signal. In PLL, the induced jitters are mainly dependent on the tracking bandwidth of the loop. The bandwidth of the loop is usually set to be less than 1/10 of the oscillation frequency due to phase margin sufficiency and stability considerations. This control delay causes the PLL to suffer from a low tracking rate.

The tracking bandwidth is the primary difference between the PLL and a phase picker. The feed forward architecture advances intrinsic bandwidth limitations. Since sampled data processing is implemented digitally, the required area and power dissipation can be decreased. The interference tolerance of a high-speed data link system, however, must be enlarged to maintain performance. As a result, the over-sampling rate in phase-picking CDR must also be increased. The high over-sampling rate leads to greater complexity and more power dissipation. In order to maintain high data link performance, a high accuracy and low power CDR is crucial in the data link system.

In a data link system, the signal integrity is degraded by noise interference as shown in FIG. 2. The waveform (D_{RX}) of data received at the receiving end is slightly different from the waveform (DTX) of original data at the transmitting end due to channel imperfections. The degradation of integrity introduces interference into data transition and makes the eye of transmission data narrow as shown in FIG. 3. An eye pattern provides useful information about the performance of a data transmission system. The interference can be classified into deterministic and random, wherein deterministic interference is mainly caused by Inter Symbol Interference (ISI) and duty cycle distortion, whereas random interference is mainly generated by noise sources such as thermal noise, power supply noise, and substrate noise.

As shown in FIG. 3, the received signal 34 has a narrow eye compared to the original signal 32 at the transmitting end. An eye pattern is defined as the synchronized superposition of all possible realizations of the signal of interest viewed within a particular signaling interval. The eye pattern derives its name from the fact that it resembles the human eye for binary waves, and the interior region of the eye pattern is called the eye opening. The width of the eye opening defines the time interval over which the received signal can be sampled without error from ISI, and it is apparent that the preferred time for sampling is the instant of time at which the eye is open the widest. The height of the eye opening, at a specified sampling time, defines the noise margin of the system. Therefore, a narrow eye makes data sampling difficult thus increasing the bit error rate.

### SUMMARY

Systems and methods for phase-picking clock and data recovery (CDR) are provided. The signal integrity in the receiver is retrieved by extending the eye of the received data stream, which leads to higher accuracy of data recovery. The proposed eye extension method improves the capability of the CDR without increasing the number of phases of the sampling clock, thus the power dissipation and cost can be efficiently reduced. The original sampled data from the receiver is fed to perform eye extension, and by regenerating the sampled data, the width of the eye is adequately expanded. An embodiment of such a method comprises examining transitions of adjacent samples, detecting whether an island sample exists in each symbol according to the separation of the transitions, and altering the value of the neighboring samples near the island sample to be equal to the island sample. The island sample can be defined as the separation of two transitions equaling one sample or at most two samples.

An embodiment provides a phase-picking clock and data recovery (CDR) system, comprises a first sample register, a delay block, a second sample register, an eye extension block, a transition detector, an accumulator, and a select generator. The eye extension block receives the sampled data from the first sample register and regenerates the samples to expand the eye of the transmission data. The transition detector detects transitions of adjacent samples received from the first sample register, and indicates bit boundaries for each symbol. In the accumulator, the transition detector information is accumulated to guarantee sufficient transitions by averaging bit-to-bit variations. Once the transition position is determined, the select generator creates a signal to select the center sample within the bit boundaries as the desired data.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic diagram illustrating a phase-lock loop (PLL) of the related art.

FIG. 2 illustrates the signal integrity degradation induced by the channel.

FIG. 3 illustrates the transmission signal eye narrowing symptom due to signal integrity degradation.

FIG. 4 shows the block diagram of an embodiment of a phase-picking clock and data recovery scheme.

FIG. 5 shows the block diagram of an eye-extension phase-picking clock and data recovery scheme according to an embodiment of the present invention.

FIG. 6 illustrates an example of island sample detection.

FIG. 7 illustrates an example of island sample replacement according to an embodiment of the present invention.

FIG. 8 is a block diagram illustrating the structure of an eye extension block according to an embodiment of the present invention.

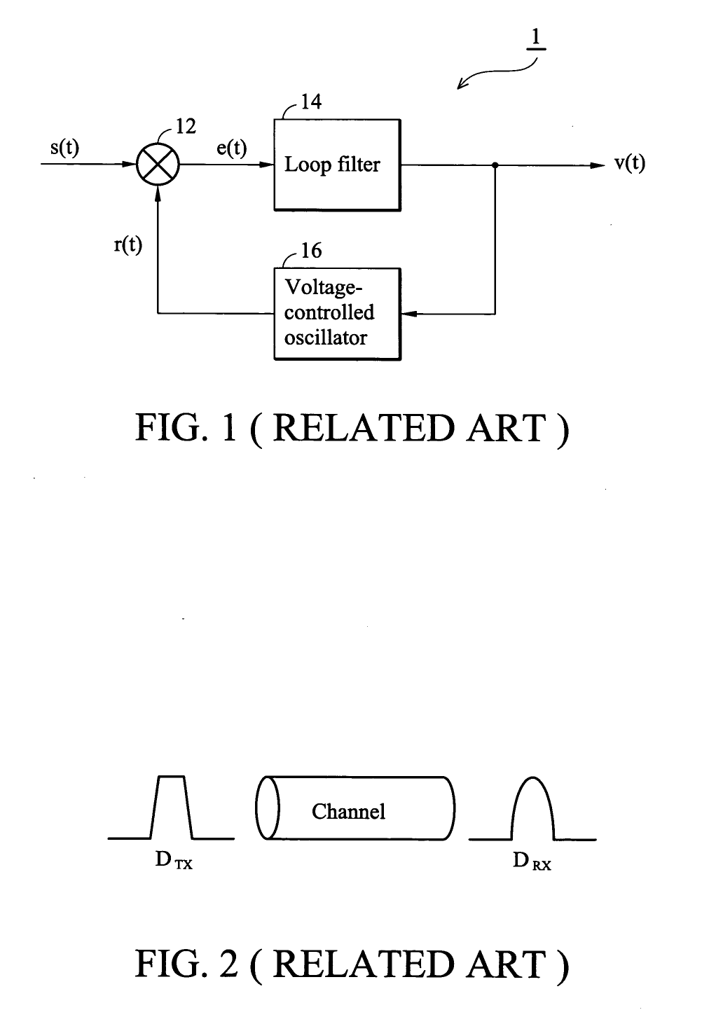

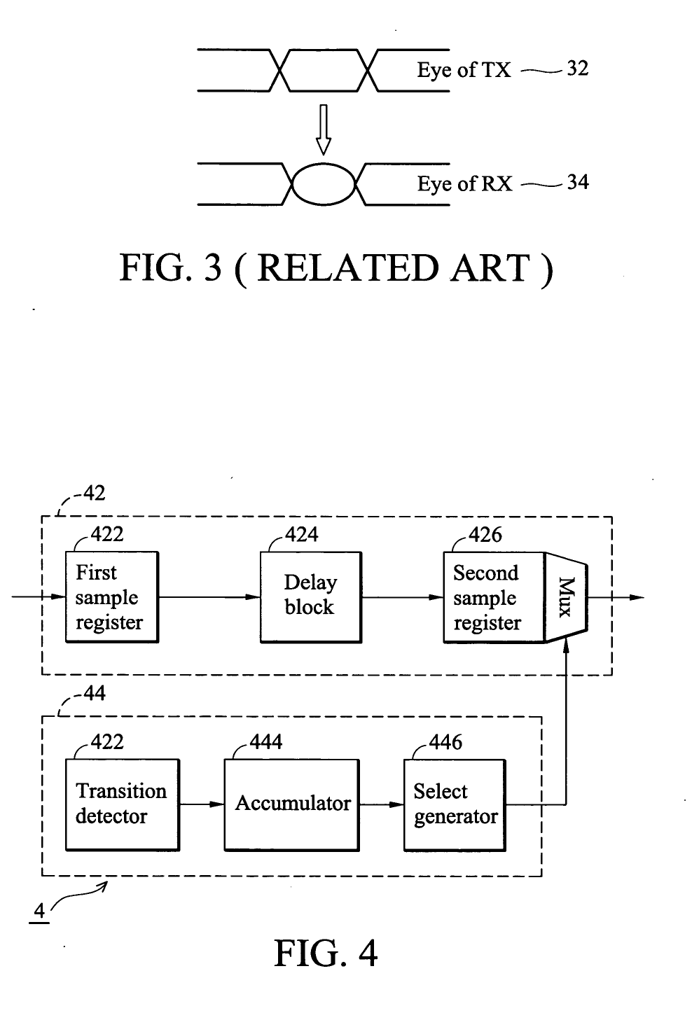

### DETAILED DESCRIPTION

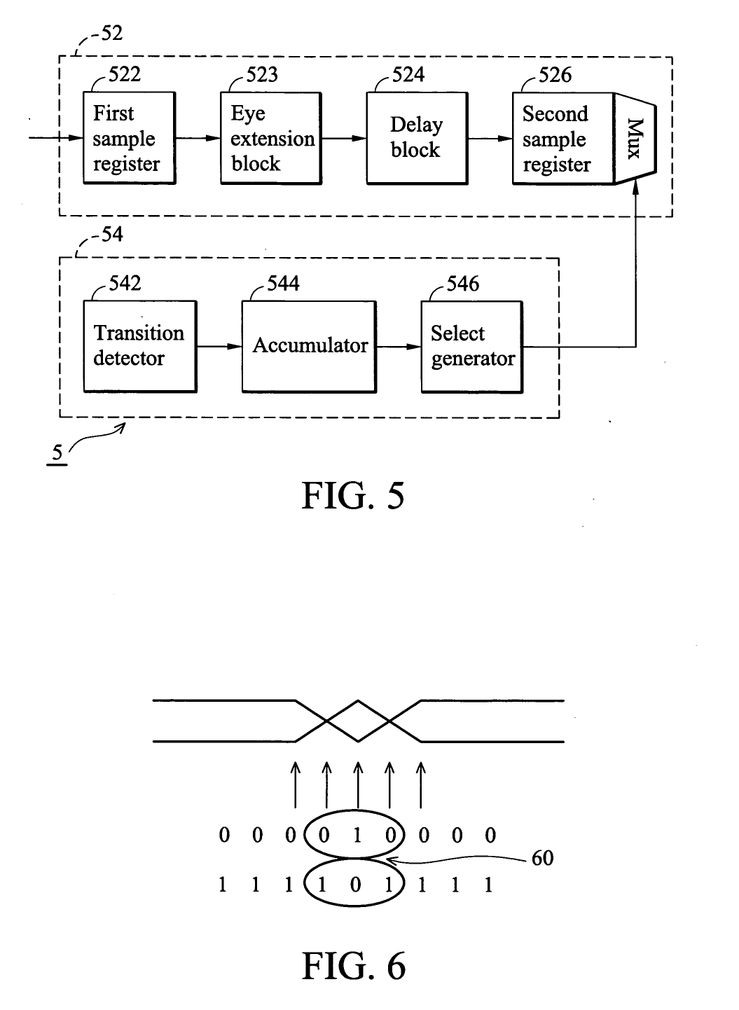

FIG. 5 is a block diagram illustrating a phase-picking CDR scheme 5 that uses an embodiment of an eye extension technique. The phase-picking CDR scheme 5 is similar to a conventional phase-picking CDR scheme 4 shown in FIG. 4, except an additional eye extension block 523 is composed between a first sample register 522 and a delay block 524.

The phase-picking CDR scheme 4 shown in FIG. 4 can be generally classified into two parts: sample processing block 42 and decision logic block 44. The sample processing block 42 comprises two sample registers 422, 426, and a delay block 424. The received samples are first registered in the first sample register 422. After passing through the delay block 424, the samples are sent into the second sample register 426. The function of the delay block 424 is to hold the samples for a specific time period in order to correspond to the current output of the decision logic block 44. The decision logic block 44 comprises a transition detector 442, an accumulator 444, and a select generator 446. The transition detector 442 first detects the transitions of adjacent samples and indicates the bit boundaries. The accumulator 444 ensures that sufficient information is obtained from the transition detector 442 by accumulating the transitions to average the bit-to-bit variations. Once the transition position is determined, the select generator 446 creates a signal to select the center sample within the bit boundaries as the desired output of the sample processing block 42.

In the phase-picking CDR scheme 5 shown in FIG. 5, the original sampled data from the receiver are first stored in a first sample register 522 and then provided to the eye extension block 523 before being sent to the delay block 524 and second sample register 526. In the eye extension block 523, the received sample stream is examined in order to detect the existence of an island sample.

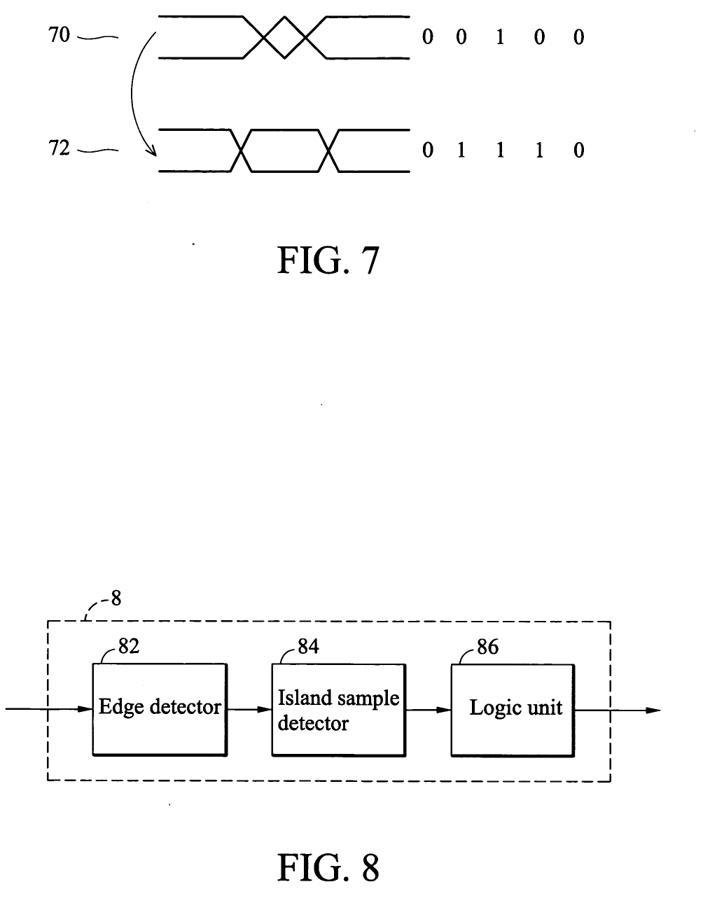

As shown in FIG. 6, the island sample 60 is defined as an odd sample in the middle of a symbol differing from its neighboring samples. Assuming that each symbol is sampled into five samples before being provided to the CDR scheme 5 of FIG. 5, exemplary symbols with an island sample are “00100” and “11011”. The eye pattern of a symbol comprising an island sample is narrow, thus requiring the eye extension block 523 to perform eye expansion. The eye extension block 523 sets the value of the samples neighboring the island sample to be identical to the island sample. FIG. 7 illustrates the island sample replacement as previously described if the original symbol 70 is “00100”. After altering the value of the neighboring samples next to the island sample, the symbol 72 becomes “01110”, and consequently, the width of the eye in the transmission data is enlarged. With the extended eye, more effective samples in the second sample register 526 shown in FIG. 5 can be selected by the select generator 546, thereby improving the accuracy of the data transmission.

Another embodiment provides an eye extension apparatus for phase-picking CDR comprises an edge detector, an island sample detector, and a logic unit. FIG. 8 illustrates an eye extension block 8 that can be implemented as the eye extension block 523 in the phase-picking CDR scheme 5 shown in FIG. 5. The edge detector 82 receives a stream of transmission data and examines the transitions of adjacent samples in each symbol. Each received symbol is represented by several samples, and the island sample detector detects whether an island sample exists in the symbol according to the separation of the transitions. For example, the separation of transitions in symbol “00100” is only one sample, whereas the separation of transitions in symbol “01110” is three samples. The separation of transitions indicates the width of the eye pattern, thus the symbols with narrow eye (narrow separation of transitions) are provided to the logic unit 86 for eye expansion. The logic unit 86 changes the value of the neighboring samples next to the island sample to be equal to the island sample, in order to enlarge the width of the eye. FIG. 7 shows an example of altering the sample values from “00100” to “01110”.

The definition of an island sample may be adjustable, and the island sample replacement can also be varied according to the system. For example, a symbol which is sampled into 7 samples is detected to include an island sample if the received symbol is either “0001000”, “1110111”, “0011000”, “1100111”, “0001100”, or “1110011”. In some embodiments of the present invention, the eye can be extended by replacing the exemplary symbols shown in the above with symbols like “0011100” or “1100011”. Many other modifications are possible based on the concepts of eye extension disclosed.

The disclosed eye extension techniques can potentially improve the capability of CDR without increasing the number of sampling clock phases. Compared to conventional phase-picking CDR, higher interference tolerance may be achieved with less power dissipation and system complexity.

Finally, while the invention has been described by way of example and in terms of the above, it is to be understood that the invention is not limited to the disclosed embodiments. On the contrary, it is intended to cover various modifications as would be apparent to those skilled in the art.

What is claimed is:

1. A method for phase-picking clock and data recovery (CDR), comprising the following steps:
examining transitions of adjacent samples in an over-sampled symbol of transmission data;
detecting whether an island sample exists in the symbol according to the separation of transitions within the symbol; and
altering the value of at least one neighboring sample of the island sample whereby the eye of the transmission data is expanded.

2. The method according to claim 1, wherein existence of the island sample is detected when the separation of two transitions within a symbol is one sample.

3. The method according to claim 1, wherein existence of the island sample is detected when the separation of two transitions within a symbol is not more than two samples.

4. The method according to claim 1, wherein the value of a neighboring sample next to the island sample is altered to equal the island sample.

5. The method according to claim 1, wherein each symbol is sampled into five samples.

6. A phase-picking clock and data recovery (CDR) system, comprising:
an edge detector, operative to receive a stream of transmission data and to examine transitions of adjacent samples in an over-sampled symbol therein;
an island sample detector coupled to the edge detector, the island sample detector being operative to detect whether an island sample exists in the symbol according to the separation of the transitions within the symbol; and
a logic unit activated by the island sample detector when the island sample is detected, the logic unit being operative to alter the value of at least one neighboring sample of the island sample, whereby the eye width of the transmission data is expanded.

7. The system according to claim 6, wherein the island sample detector detects the island sample if the separation of two transitions within a symbol is one sample.

8. The system according to claim 6, wherein the island sample detector detects the island sample if the separation of two transitions within a symbol is no more than two samples.

9. The system according to claim 6, wherein the logic unit levels the value of the at least one neighboring sample to be equal to the island sample.

10. The system according to claim 6, wherein each symbol is sampled into five samples.

11. A phase-picking clock and data recovery (CDR) system, comprising:
a sample register, operative to store received samples, wherein a symbol is sampled into a plurality of samples;
an eye extension block, operative to obtain the samples from the sample register, detecting whether an island sample exist in the symbol according to the separation of transitions of adjacent samples, and altering the value of at least one neighboring sample next to the island sample;
a transition detector, operative to receive the samples from the sample register, detecting transitions of adjacent samples, and indicating bit boundaries for the symbol;
an accumulator, operative to accumulate and average the boundary information output from the transition detector in order to determine a best appropriate sample to recover data carried in the symbol; and
a select generator, operative to generate a signal to select the best appropriate sample of the symbol output from the eye extension block.

12. The phase-picking CDR system according to claim 11, further comprising a delay block operative to delay the output of the eye extension block, and a second sample register operative to store the samples passed from the delay block for the select generator to perform sample selection.

13. The phase-picking CDR system according to claim 11, wherein the symbol is sampled into five samples.

14. The phase-picking CDR system according to claim 11, wherein the eye extension block judges that the island sample is detected when the separation of two transitions within a symbol is one sample.

15. The phase-picking CDR system according to claim 11, wherein the eye extension block judges that the island sample is detected when the separation of two transitions within a symbol is no more than two samples.

16. The phase-picking CDR system according to claim 11, wherein the eye extension block levels the value of the at least one neighboring sample next to the island sample to be equal to the island sample.
